(19) United States
(12) Patent Application Publication
(10) Pub. No.: US 2006/0059524 A1
(43) Pub. Date: Mar. 16, 2006

(54) Audio and video storage broadcast media system

(76) Inventor: Jhy Hwa Sung, Taipei City (TW)

Correspondence Address: Jhy Hwa Sung, 235 Chung-Ho, Box 8-24, Taipei, TW

(21) Appl. No.: 10/942,328

(22) Filed: Sep. 16, 2004

(51) Int. Cl. H04N 7/18; H04N 7/173

(52) U.S. Cl. 725/80; 725/74; 725/100

(57) ABSTRACT

The main function of broadcast media AV system is a bridge to connect between PC (personal computer) and TV (television). This device can store the AV bit stream downloaded from Internet through PC to a storage device, HD (hard disk) and flash memory, in this broadcast media AV system. When users want to display the stored medium, they can select the media through input mediums, such as touch buttons, remote control, and character input, to choose different mediums. This device can automatically select the different formats of AV medium by itself. After manipulated the AV bit stream through the device, the device can convert digital signals to analog signals or directly use digital signal interface to display the medium on the TV.

### FIELD OF THE INVENTION

The present invention relates to medium system, and particular to an AV storage broadcast media system, wherein AV data can be got and displayed easily, even it can be used to replace the playing system of current VCD or DVD personal mediums without needing to buy or rent disks. The AV data can be downloaded from networks through the present invention.

### BACKGROUND OF THE INVENTION

Since the improvement of network technology, many multi-media data can be downloaded from networks, such as video data, audio data, photo, etc. The general used image data format includes MPEGx, opendivs, RMP4, Xvid, AVI, Quicktime, and RMVB, etc. The audio data format includes MPEG audio layer 1, 2 and 3 (MP3), WMA, AAC, iTune, AC3, Ogg vorbis, and PCM wave, etc. The photo format includes Bitmap, GIF, TIF, PNG, JPEG, etc. Each format has its advantages and disadvantages, which are used in the network states through the networks.

Generally, when the AV (audio/video) data is used to a network, the MPEG and AVI are most frequently used formats. Currently, RMVB (Real Media Variable Bit Rate) developed by Realone System is also used frequently. In this format, based on assuring an average compression ratio, a greater sample rate twice of general used one is set. A larger bit rate is used to a complicated frame. In a static frame, a lower sample rate is used. The bit rate is used effectively. In RMVB, the size of frames of a movie is compressed to an optimum extent by neglecting the sections, which are not viewed clearly by the viewers. Thereby, the AV effect of a DVD is nearly perfect.

When a network user downloads a certain AV data format from a network, which provides a content data, it is necessary that the display software stored in the computer can be viewed on a computer screen. No matter whether they are stored in the hard disk of the user's computer.

The frequent used AV contents include movies, news, sports, etc., which are suitable to be displayed on televisions. With the trend of minimization of electronic devices, such as computers, palm type computers; the sizes of the displays are more and more smaller, for example, the display screens of handsets are only 13 cm². It cannot provide a preferred AV content to the viewers. Furthermore, current personal multi-media only keep attention to the development of MP3, in which AV data of RMVB format cannot be displayed. Thereby, there is an eager demand for a novel AV storage and display system, which can transfer AV data, which are propagated in networks from personal computers to televisions.

Such kinds of AV storage broadcast media system can be connected to a network through personal devices or communication networks, such as personal computers or wireless handsets. The AV data can be downloaded from networks to be displayed on televisions. Thereby, the user can operate easily and conveniently with a preferred AV effect.

### SUMMARY OF THE INVENTION

Accordingly, the primary object of the present invention is to provide an AV storage broadcast media system comprising: a personal medium having a connection interface, a data storage device, a control device and an AV output interface; a communication network; a personal device being connected to the connection interface; the personal device being accessible to the communication network for downloading AV data or AV data being stored in the personal device. The AV data of the personal is being stored to the data storage device, the control device decoding the AV data and processing the digital AV data. Then the AV data is converted into analog signals from digital signals. The converted analog signals are transferred to a television through the AV output interface so as to display contents of the AV data on the television.

Another object of the present invention is to provide a personal medium having a connection interface, a data storage device, a control device and an AV output interface; the data storage device being connected to a personal device through the connection interface and thus being connected to a communication network for downloading AV data from the communication network; or downloading AV data in the personal device directly; and the control device decoding the AV data and processing the digital AV data; then the AV data being converted into analog signals from digital signals, and the converted analog signals being transferred to a television through the AV output interface so as to display contents of the AV data on the television.

Furthermore, the digital effects of the control device may be a reduction of blocking effect and noise, upscaler effect, sharpness, chrominance transition improvement, contrast brightness control, gamma correction, macrovision protection, and TV encoding, etc. TV encoding section serves for converting AV signals from digital signals into analog signals.

Moreover, in the AV storage broadcast media system of the present invention, the AV data can be got and displayed easily, even it can be used to replace the playing system of current VCD or DVD personal mediums without needing to buy or rent disks. The AV data can be downloaded from networks through the present invention.

The various objects and advantages of the present invention will be more readily understood from the following detailed description when read in conjunction with the appended drawing.

### BRIEF DESCRIPTION OF THE DRAWINGS

FIG. 1 is a system structural view of the present invention.

FIG. 2 shows one embodiment of the personal media of the present invention.

FIG. 3 shows the perspective view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

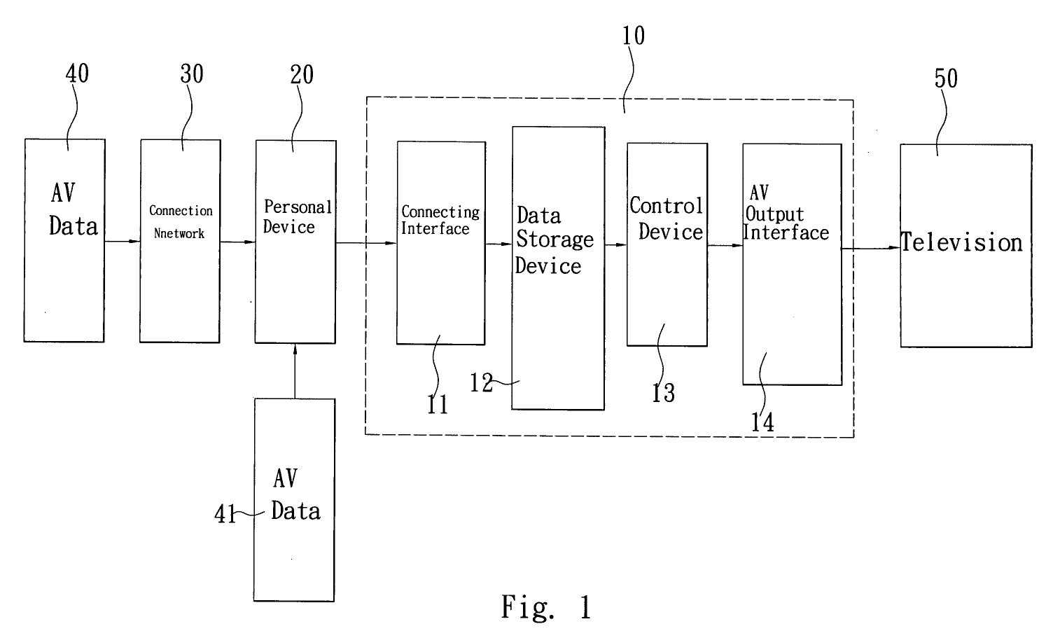

Referring to FIG. 1, the system structure of the present invention is illustrated. The AV storage broadcast media system 10 of the present invention has the following elements.

A data storage device 12 is connected to a personal device 20 through a connecting interface 11. The personal device 20 is selected from one of a personal computer, a palm top computer, or a communication handset, which is capable of being connected to a communication network 30 so as to download content of AV data thereform and then store the data.

The connection network 30 is a wire network or a wireless network. Currently, it is preferred that the connecting interface 11 is an USB interface or an IEEE 1394 (Firewire) interface which can be directly inserted into a personal computer so as to be connected to the connection network 30.

The AV (audio and video) data 40 is such as video data, audio data, and photos, etc. The useable image formats are such as MPEGx, opendivs, RMP4, Xvid, AVI, Quicktime, RMVB, etc. The usable audio formats are such as AC3, Ogg vorbis, and PCM wave, etc. The usable photo data are such as Bitmap, GIF, TIF, PNG, JPEG, etc.

Furthermore, the AV data can be AV data 41 directly stored in a personal computer (such as computer hard disk).

A control device 13 is installed in the AV storage broadcast media system 10. The control device 13 is preferably a remote controller (not shown) so that the AV data 40 in the connection network and the AV data 41 of the personal device can be downloaded.

A data storage device 12 serves for storing the downloaded AV data.

The control device 13 serves to decode the data downloaded from the data storage device 12 and image-processed the data. Then the AV data is converted from digital data into analog data through a TV encoder.

An AV output interface 14 serves for receiving the analog AV data and then inputted into a television 50 so that the AV contents, such as films, movies, audios, or photos, etc. of the AV data can be displayed on the television.

There are two methods for connecting the AV output interface 14 to a television, by an NTSC/PAL encoder or by wireless way (such as IEEE 802.11.x). The NTSC/PAL encoder uses YUV/RGB connectors or s-video connectors.

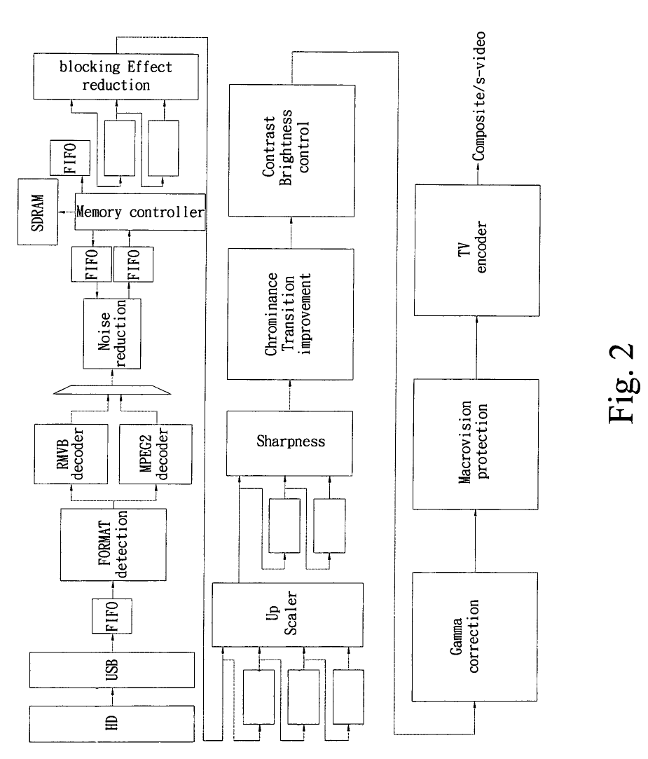

In FIG. 2, another embodiment of the AV storage broadcast media system according to the present invention is illustrated. The data storage device 12 is a hard disk HD and the connecting interface 11 is an USB or an IEEE 1394 (Firewire) interface.

The control device 13 is mainly a memory controller, which is connected to a memory, such as a SDRAM memory. The required control programs are stored in the memory. The format of the AV data must be detected in advance, for example, RMVB, AVI or MPEG and then the AV data is decoded. Then, the decoded AV data is processed for added digital effects.

The digital effects of the control device 13 may be a reduction of blocking effect and noise, upscaler effect, sharpness, chrominance transition improvement, contrast brightness control, gamma correction, macrovision protection, and TV encoding, etc. The functions will be described in the following.

Noise reduction section serves for reduction of the noise from AV conversion.

Memory controller section serves for performing AV data transmission from TV to DRAM.

Blocking effect reduction section serves for clearing the blurry effect of AV signals, because the AV data from the television has a high compression ratio. If it is displayed on the television, it will be burry.

Upscaler section serves for extending AV signals for matching the display requirement of televisions.

Sharpness section serves for enhancing the hue of the color (Y) on the television so as to smooth the AV signals on the television.

Chrominance transition improvement section has a function like that of the sharpness section, but it is used to enhance the color (U and V) of the AV signals on the television.

Contrast brightness control section serves for controlling the contrast so as to play the visual effect of the user.

Gamma correction section serves for enhancing the human visual effect since the YUV of the AV signals on the display device is non-linear.

Macrovision protection serves for preventing the AV signals to be used illegally before displayed.

TV encoding section serves for converting AV signals from digital signals into analog signals.

After above-mentioned process, the AV output interface 14 is connected to the television 50 through proper wires so as to display the content of AV data on the television.

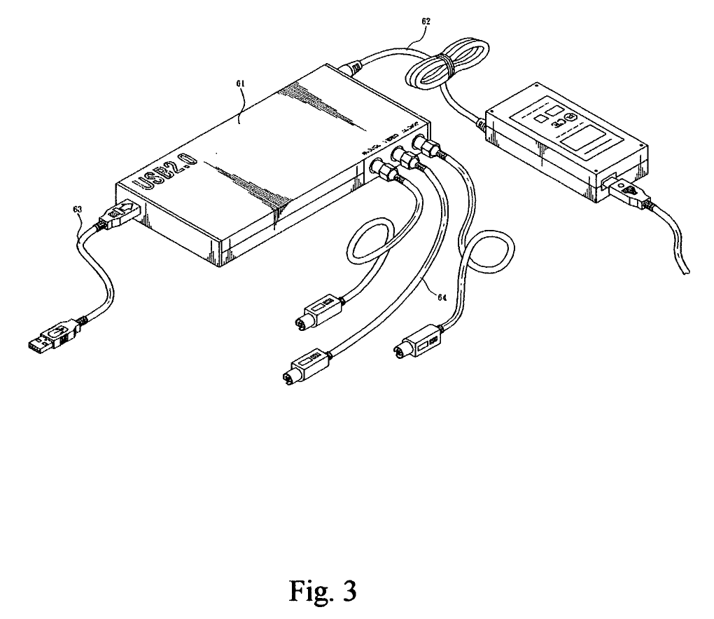

In the present invention, the AV storage broadcast media system is portable, as shown in FIG. 3, the data storage device 12 and the control device 13 is installed in a casing 61. The data storage device 12 is a 12-1 flash card reader, an external hard disk, or a thumb driver, etc. The control device 13 is a special designed integrated circuit IC.

Referring to FIG. 3, the AV storage broadcast media system of the present invention has a power supply from a power wire 62. An USB or an IEEE 1394 (Firewire) wire 63 is connected to an USB interface of a personal device for downloading AV data from the display of a television.

In the drawing, the AV wire 64 may be an s-video connector or a YUV/RGB connector used in NTS/PAL. However, a wireless communication system is served in this purpose, such as an 802.11.x system.

In the present invention, the device for displaying AV data may be a television or a high definition TV (HDTV) having a CCIR 656, 601 DVI output.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An AV storage broadcast media system comprising:
A personal medium having a connection interface, a data storage device, a control device and an AV output interface;
a communication network;
a personal device being connected to the connection interface; the personal device being accessible to the communication network for downloading AV data or AV data being stored in the personal device;
Wherein the AV data of the personal device being stored to the data storage device; the control device decoding the AV data and digital-processing the decoding AV data; then the AV data being converted into analog signals from digital signals, then the converted analog signals being transferred to a television through the AV output interface so as to display contents of the AV data on the television.

2. The AV storage broadcast media system as claimed in claim 1, wherein the connection interface of the personal medium is one of a USP and IEEE 1394 (Fireware) interface.

3. The AV storage broadcast media system as claimed in claim 1, wherein the data storage device of the personal medium is one of 12-1 flash card readers, external hard disks, and portable disks.

4. The AV storage broadcast media system as claimed in claim 1, wherein the digital processing of the control device of the personal medium includes a reduction of blocking effect and noise, upscaler effect, sharpness, chrominance transition improvement, contrast brightness control, gamma correction, macrovision protection, and TV encoding.

5. The AV storage broadcast media system as claimed in claim 1, wherein the AV output interface of the personal medium is one of an NTSC/PAL encoding system and a wireless system.

6. The AV storage broadcast media system as claimed in claim 5, wherein the NTSC/PAL encoding system uses one of YUV/RGB connectors and s-video connectors.

7. The AV storage broadcast media system as claimed in claim 1, wherein the communication network is one of a wire network and a communication network.

8. The AV storage broadcast media system as claimed in claim 1, wherein the television is one of analog televisions and high definition televisions with CCIR656, 601 DVI outputs.

9. The AV storage broadcast media system as claimed in claim 1, wherein the personal medium is one of personal computers, palm top computers, and wireless handsets.

10. A personal medium having a connection interface, a data storage device, a control device and an AV output interface;
The data storage device being connected to a personal device through the connection interface and thus being connected to a communication network for downloading AV data from the communication network; or to downloading AV data in the personal device directly; and
the control device decoding the AV data and digital-processing the decoding AV data; then the AV data being converted into analog signals from digital signals, then the converted analog signals being transferred to a television through the AV output interface so as to display contents of the AV data on the television.

11. The AV storage broadcast media system as claimed in claim 10, wherein the AV data is one of video data, audio data, and photo data.

12. The AV storage broadcast media system as claimed in claim 10, wherein a format of the AV data is one of MPEG, AVI and RMVB.

13. The AV storage broadcast media system as claimed in claim 10, wherein the connection interface of the personal medium is one of a USP and IEEE 1394 (Fireware) interface.

14. The AV storage broadcast media system as claimed in claim 10, wherein the data storage device of the personal medium is one of 12-1 flash card readers, external hard disks, and portable disks.

15. The AV storage broadcast media system as claimed in claim 10, wherein the digital processing of the control device in the personal medium includes a reduction of blocking effect and noise, upscaler effect, sharpness, chrominance transition improvement, contrast brightness control, gamma correction, macrovision protection, and TV encoding.

16. The AV storage broadcast media system as claimed in claim 10, wherein the AV output interface of the personal medium is one of a NTSC/PAL encoding system and a wireless system.

17. The AV storage broadcast media system as claimed in claim 16, wherein the NTSC/PAL encoding system uses one of YUV/RGB connectors and s-video connectors.
